(19) United States
(12) Patent Application Publication
(10) Pub. No.: US 2013/0043445 A1
(43) Pub. Date: Feb. 21, 2013

(54) TELESCOPICALLY LENGHTENING/SHORTENING POWER UNIT

(71) Applicant: Veli-Matti Ilari Jussila, Lempaala (FI)

(72) Inventor: Veli-Matti Ilari Jussila, Lempaala (FI)

(73) Assignee: VELVISION OY, Tampere (FI)

(21) Appl. No.: 13/577,062

(22) PCT Filed: Feb. 4, 2011
(86) PCT No.: PCT/FI2011/000007

§ 371 Date: Oct. 1, 2012

(30) Foreign Application Priority Data
Feb. 5, 2010 (FI) 20100042

(51) Int. Cl. B66F 3/10; B66F 19/00

(52) U.S. Cl. 254/102

(57) ABSTRACT

Power unit that can be telescopically lengthened/shortened and performs linear movement which power unit comprises cylindrical parts (1-3) moving telescopically within each other in which case the mentioned parts are equipped with at least external or internal threads in such a way that the mentioned parts form a power unit that can be lengthened/shortened when the parts are being rotated in relation to each other and that at least one part (3) of the mentioned parts (1-3) is locked to be non-rotating or locked to rotate in a different way than the part (1) of the mentioned parts (1-3) to which part a rotating producing movement to the power unit is arranged. In order to reduce the construction weight of the power unit the mentioned parts (1-3) are made of plastic and of the mentioned parts the inner diameter (d) of the part (3) having the smallest diameter is over 25% of the useful height (H) produced by the mentioned smallest part.

Invention relates to a power unit performing linear movement and that can be telescopically lengthened/shortened which power unit comprises cylindrical parts that move telescopically within each other in which case the mentioned parts are equipped at least with external or internal threads in such a way that the mentioned parts form a power unit that can be lengthened/shortened by rotating them in relation to each other and that at least one part of the mentioned parts is locked to be non rotating or locked to rotate in a different way than the part of the mentioned parts to which part rotating causing movement for the power unit is arranged.

Previously cylinders that can be extended with hydraulic pressure or compressed air are known as power units that can be telescopically extended. The purpose of use of these is mostly lifting in which case the recovery of the cylinder to be short occurs with the help of gravitational force by letting the pressure out of the cylinders. If gravitational force and removal of the pressure cannot be used to pull this kind of cylinder back to be short, mechanical pulling devices, such as withdraws occuring with a wire draw are known.

From a Chinese publication CN 2809309Y telescopic parts equipped with threads that are needed for uplifting of a lifting platform construction are known which telescopic parts can be extended and shortened in relation to each other by rotating. In this construction the telescopic parts are made of metal and they are considerably heavy. In order to avoid excessive increase of the weight, the telescopic parts have as small diameter as possible. In order to function, one such power unit requires yet the fact that at least one telescopic part is locked to be non-rotating. A construction that has a size of the power unit will thus cause more additional weight with which construction the opposite end is locked to be non-rotating in relation to the location of the rotating device of the power unit. When the telescopic parts are made to have small diameters in order to save weight, the construction will buckle easily if one tries to achieve great endurance of the load and lifting height or great elongation with it.

With the power unit equipped with telescopic parts according to the invention unexpected improvements can be achieved to the existing prior art and it is characteristic of the invention that in order to reduce the construction weight of the power unit the mentioned parts are made of plastic and of the mentioned parts the inner diameter of the part having the smallest diameter is over 25% of the useful height produced by the mentioned smallest part.

The advantage of the power unit according to the invention is its lightness, weather resistance and a great buckling resistance. Further the power unit is not position sensitive but functions in all positions in a controlled way by lengthening and shortening. Therefore it is suitable for a vertical and horizontal installation and also is suitable for any installation direction. The locking of the one end of the power unit to be non-rotating when the other end is being rotated can be performed with the help of a profile bar directed inside the power unit and also with the help of an external construction of the power unit if the above mentioned locking is necessary.

The rotating equipment of the rotatable telescopic part and the gearing belonging to it, such as a planetary gear can be adjusted even inside the part itself in which case the construction length of the power unit does not become longer. When the telescopic parts are plastic cylinders with relatively thick walls, their threads are easy to manufacture, a lot of bearing area can be gained to the threads, the threads do not become damaged easily and they don't cause significantly friction.

In the following the invention is described more detailed by referring to the accompanying drawings in which

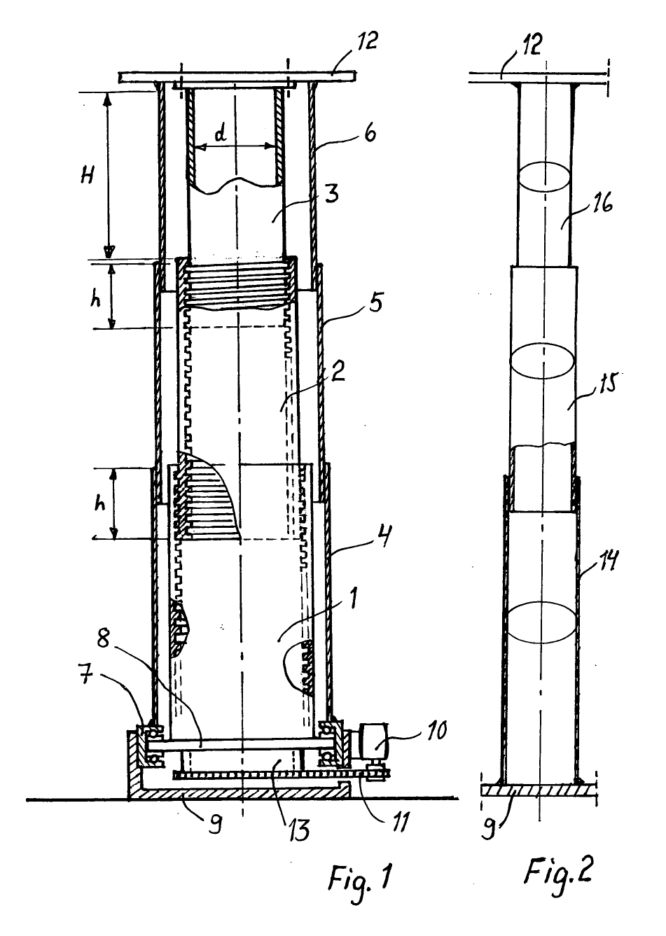

FIG. 1 shows a power unit as a side view partly sectioned.

FIG. 2 shows a telescopic profile bar.

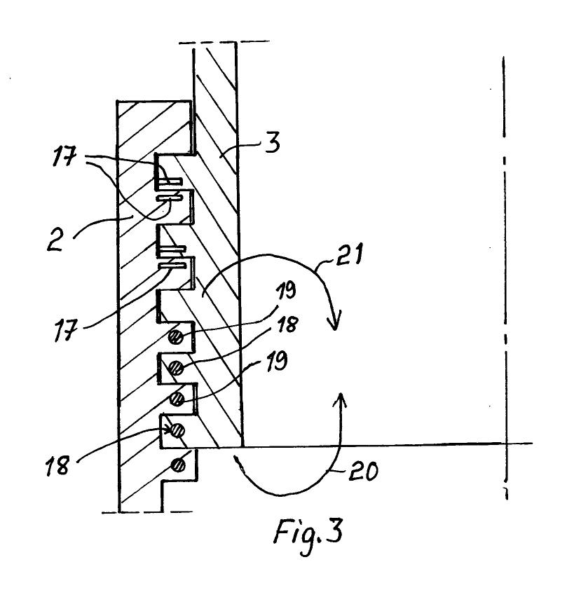

FIG. 3 shows magnetic devices installed to the threads.

In the FIG. 1 a power unit formed with the help of telescopic parts 1-3 made of plastic material is shown. The telescopic parts 1-3 are attached to each other with a thread and one implementation form is such that the inner part of each parts 1 and 2 is full of threads and there are threads at the outer surface of each part 2 and 3 at the lower part covering the distance h. When the lowest part 1 is being rotated with the help of a motor 9 and chain gear 11 and the uppermost part 3 is being kept as non-rotating, such as the base 12 belonging to the uppermost part, the power unit lengthens and shortens depending on the direction of rotation of the motor. Only the parts 1 and 2 rotate. Each thread part has most advantageously the same pitch per cycle.

The lowest, rotating part 1 of the power unit is bearing-mounted to a base 9 from its flange 8 with the help of a bearing 7. The bearing 7 receives vertical forces directed both downwards and upwards. Thus with the power unit the base 12 can be pushed when the power unit 12 is lengthening and pull it when the power unit is shortening.

In the FIG. 1 a solution to keep the base 12 and the uppermost part 3 as non-rotating with the help of an external, telescopic profile construction 4-6 is shown. The profile construction 4-6 is for example the same as quadrangular pipes attached telescopically within each other to each other. These pipes convey from the non rotating frame of the bearing 7 force that keeps the base 12 as non rotating. The profile construction functions in use also as a casing so that the threads of the parts 1-3 stay clean.

In the FIG. 2 there is a corresponding hollow profile bar 14-16 that can be adjusted inside the power unit which profile bar is attached to the base 9 from its lower end and to the base 12 from its upper end. The profile bar is elliptical regarding its cross section. Also with this rotation of the part 3 is prevented.

The part 3 can be locked to be non-rotating but regarding the functioning of the power unit it is not necessary. The part 3 can rotate, too, if it rotates in a different direction than the rotated part 1 or with a different speed than the rotated part 1.

The parts 1-3 are plastic cylinders the wall thickness of which is approximately 30 mm. In that case trapeze threads of sufficient size can easily be worked at the inner surface of the cylinders for which trapeze threads a lot of bearing area can be gained. For the smallest cylinder 3 a certain diameter size is chosen according to the maximum load of the power unit in which case the parts stay at the longest exit position and stay fully loaded without buckling yet.

The inner diameter d of each part 1-3 being made of plastic raw material is advantageously over 25% of the useful height H of the corresponding part, in other words of the part having the high limit and coming out from the previous part 1, 2.

The lightness of the power unit can be achieved with the help of plastic materials, such as polyamides used as base material of the cylinder parts 1-3 the density of which materials is 1.4 kg/dm3 or under it. The parts 1 and 2 have threads covering the whole inner surface. The part 3 has threads only at the outer surface at its lower part covering the height h. Similarly the part 2 has threads at the outer surface covering only the height h. The rotating of the parts 2 and 3 out of the previous part is prevented for example with the finishing of the inner thread part before the edge banding of the part. The rotating of the part 1 can immediately move to rotate also the part 2 till the prevention of the rotation for the part 2 occurs or first the part 1 rotates its whole movement distance and then it begins to rotate the part 2. The number of the parts 1-3 is not restricted to three but in the solutions according to the invention there can be more of them, too.

The plastic material of the parts 1-3 is most advantageously polyamide and specially most advantageously even so called self-lubricating, slippery plastic material as such or mixed with some known mineral fillers or formed to be a composite construction in order to improve the material properties, such as in order to reinforce the material, to reduce the friction in the threads or improve the weather resistance. Further the plastic material of the parts can be reinforced with known fibre reinforcements, the outer casing of the parts can be reinforced with fibres or with a reinforcement net. Also the surfaces of the threads can be treated with nanotechnology or coated in order to reduce friction.

The stress of the threads of the power unit can be lightened during the extension movement of the power unit for example by directing compressed air inside the power unit in which case the compressed air pushes the power unit to be longer.

In the FIG. 3 a solution is shown in order to reduce the friction stress of the threads in which case for example banded permanent magnets 17 are located to the threads of the parts 2 and 3 in such a way that the magnets 17 of the adjacent threads repel each other so that the magnet of the thread of the lower part 2 repels the magnet of the thread of the upper part 3 and thus aims to support the thread of the upper part 3.

As an alternative to this coils 18 located to threads to one part 3 and coils 19 to the other part 2 are shown. By leading DC current as opposite sign to the coils 18 and 19 in such a way that magnetic fields 20 and 21 repel each other, support effect to the part 3 can also be achieved through the threads.

What is claimed is:

1. A power unit that can be telescopically lengthened/shortened and performs linear movement, which power unit comprises cylindrical parts (1-3) moving telescopically within each other in which case the mentioned parts are equipped with at least external or internal threads in such a way that the mentioned parts form a power unit that can be lengthened/shortened when the parts are being rotated in relation to each other and that at least one part (3) of the mentioned parts (1-3) is locked to be non-rotating or locked to rotate in a different way than the part (1) of the mentioned parts (1-3) to which part a rotating producing movement to the power unit is arranged, characterized in that in order to reduce the construction weight of the power unit the mentioned parts (1-3) are made of plastic and of the mentioned parts the inner diameter (d) of the part (3) having the smallest diameter is over 25% of the useful height (H) produced by the mentioned smallest part.

2. The power unit according to the claim 1, characterized in that the last part (3) having the smallest diameter is attached to the base (12) in a non-rotating way.

3. The power unit according to the claim 1, characterized in that the first part (3) having the largest diameter is attached to the base in a non-rotating way.

4. The power unit according to the claim 1, characterized in that the power unit comprises a rotating motor (10) with the help of which the first (1) or the last part attached to be rotating is rotated.

5. The power unit according to the claim 1, characterized in that it comprises a telescopic bar (14-16) adjusted inside the power unit having a profile that deviates from a round form or that it comprises a corresponding, telescopic structure (4-6) being outside the power unit with the help of which construction the part (3) of the power unit meant to be non rotating can be kept as non rotating.

6. The power unit according to the claim 1, characterized in that it is adjusted to be a lifting and lowering power unit or adjusted to be a pushing and pulling power unit functioning in any direction.

7. The power unit according to the claim 1, characterized in that the threads of each part (1-3) are equipped with a pitch of equal size per a cycle.

8. The power unit according to the claim 1, characterized in that the threads of the parts (1-3) have a profile equal to trapeze threads.

9. The power unit according to the claim 1, characterized in that the parts (1-3) are made of polyamide plastic or are made of mixed/reinforced polyamide plastic.

10. The power unit according to the claim 1, characterized in that the density of the material of the plastic parts (1-3) is under 1.4 kg/dm3.

11. The power unit according to the claim 1, characterized in that the outer casings of the parts (1-3) are reinforced with fibre or net reinforcements.

12. The power unit according to the claim 1, characterized in that in order to reduce the friction between the threads, magnetic devices (17), (18), (19) are adjusted between the cylinder parts 1-3 with the help of which magnetic devices a support effect affecting the threads and reducing the surface pressure can be achieved.
